(19) United States
(12) Patent Application Publication
(10) Pub. No.: US 2018/0331538 A1
(43) Pub. Date: Nov. 15, 2018

(54) METHOD FOR CONTROLLING AT LEAST ONE ENERGY-CONSUMING APPARATUS IMPLEMENTED BY A CONTROL SYSTEM

(71) Applicant: OGGA, Lyon (FR)

(72) Inventor: Stéphane GAGNAT, Lyon (FR)

(73) Assignee: OGGA, Lyon (FR)

(21) Appl. No.: 15/776,012

(22) PCT Filed: Nov. 8, 2016
(86) PCT No.: PCT/FR2016/052889

§ 371 Date: May 14, 2018

(30) Foreign Application Priority Data
Nov. 12, 2015 (FR) 15/60815

(51) Int. Cl. H02J 3/14; G05B 13/02

(52) U.S. Cl. CPC H02J 3/14; H02J 2003/143; G05B 13/026

(57) ABSTRACT

A method for controlling at least one energy-consuming apparatus within a room or a dwelling, implemented by a control system having at least one energy-consumption sensor, a data-analysis unit, and a unit for controlling said apparatuses configured to cooperate with the analysis unit, the control method including at least one step of acquiring energy-consumption data captured by the sensor and recorded by the analysis unit, and a step of determining the occupation of the room or dwelling by the analysis unit, wherein the control method also includes a step of determining the usage and operational habits of the room or dwelling, and a step of controlling the one or more apparatuses of the one or more apparatuses of the room or dwelling in accordance with the step of determining the usage and operational habits of the room or dwelling.

The invention concerns the field of the management of energy consumption within a room or a dwelling and more particularly, of energy consumption of one or more consuming appliances.

In order to monitor the power consumption of appliances within a room or a dwelling, there are external programmers which are connected between the socket and the electrical appliance. These programmers are for example mechanical programmers including an integrated calendar and allowing to manage the power supply of the appliance without going through the electrical panel.

A method for managing the power consumption of an electrical appliance is also known, comprising at least one step of acquiring current data, a step of recording data over a determined period, a step of determining a consumption routine from the data record(s), a step of applying the consumption routine so as to cut the power supply of the unused appliance(s) in the identified periods.

The objective of the invention is to improve the solutions proposed by the state of the art described above by taking into account the energy consumption habits within the dwelling or the room and the presence/absence of a user in the room or the dwelling, which allows being adapted to a possible change of the needs and if necessary anticipating the needs of the users.

The object of the invention is a method for controlling at least one energy-consuming appliance within a room or a dwelling, implemented by a control system comprising at least one energy consumption sensor, a data analysis unit, a control unit of said appliances configured to cooperate with the analysis unit, the control method comprising at least one step of acquiring energy consumption data sensed by the sensor and recorded by the analysis unit and a step of determining whether the room or the dwelling is occupied by the analysis unit,
characterized in that the control method further comprises:
(a) a step of determining the use and operation habits of the room or the dwelling, said step comprising the following sub-steps:
classifying the data from the recording made previously, the classification being made according to the type of consumption: resistive and/or capacitive and/or inductive consumption; and/or according to the average value and/or the frequency and/or the duration and/or the maximum and minimum values of said data.
analyzing the occurrence frequency of distinct consumption cycles from the recording of the consumption data and/or the determination of whether the room or the dwelling is occupied,
determining the type of appliance according to the occurrence frequency of the consumptions and/or the presence/absence of a user, from the classification of the data and the analysis of the occurrence frequency of the consumption cycle,
(b) a step of controlling the appliance(s) of the room or the dwelling, from the step of determining the use and operation habits of the room or the dwelling.

The control method according to the invention allows a management adapted to the uses and the needs of the users of the energy consumption of the appliances in a room or a dwelling.

Advantageously, the classification allows distinguishing the periods during which the dwelling has consumed energy due to the presence/absence of a user or only due to the automatic operation of appliances.

Advantageously, the temporal analysis of these information allows determining use habits and therefore determining the periods during which it is unlikely that users are present and, conversely, the periods when it is almost certain that users are present in the room or the dwelling. Furthermore, associated to the lifestyle of the user, it allows determining the periods when it is quite likely that the users are sleeping. This information is much easier to confirm that this period is very often framed by two periods of use of the energy generated by the user.

In the present application, the term “energy consumption” means the power and/or gas and/or fuel oil and/or hot water consumption.

According to a feature of the invention, the control method comprises a spectrum calculation step allowing the classification according to the type of consumption: resistive and/or capacitive and/or inductive consumption.

According to a feature of the invention, the step of acquiring the energy consumption data comprises the following sub-steps:
receiving the energy consumption data by the analysis unit,
recording said data in a time table showing the consumption over a determined period.

According to a feature of the invention, during the recording of the data, a date and a time are affixed to each data.

According to a feature of the invention, the determined period may be of several days, for example for one week.

According to a feature of the invention, the data acquisition is carried out continuously and/or sequentially.

According to a feature of the invention, the step of determining whether the room or the dwelling is occupied comprises the following sub-steps:
acquiring presence/absence data of one or more user(s) in the room or dwelling by means of a presence/absence sensor of the control system,
analyzing the data acquired by the sensor or by the analysis unit of the control system.

According to a feature of the invention, the step of determining whether the room or the dwelling is occupied may be carried out at the same time as the step of acquiring energy consumption data or the step of recording said data.

According to a feature of the invention, at least one first cycle is identified from the records of the consumption data, the first cycle being a cycle called machine cycle, grouping the consumptions performed unrelated to the presence/absence of a user in the room or the dwelling.

According to another feature of the invention, the control method comprises a step of associating said consumptions grouped in a machine cycle with one or more appliance(s).

According to a feature of the invention, at least one second cycle identified from the records of the consumption data, the second cycle being a cycle called user cycle, grouping the consumptions which are related to the presence/absence of one or more user(s).

According to another feature of the invention, the control method comprises a step of determining the share of consumption of the appliance(s) in a user cycle by comparing the machine cycle(s) with the user cycle(s), which allows discerning the number and the power required by the appliances.

According to a feature of the invention, the control method, further comprises a step of creating a life habit table, said step comprising the following sub-steps:
creating a data table indicating the standard consumptions of the appliances from the determination of the type of product,
creating a data table indicating the standard consumptions of the dwelling or the room depending on the presence/absence of the users.

Advantageously, the life habit table serves as an abacus and allows anticipating the needs of the users by allowing a monitoring in advance of some appliances.

According to another feature of the invention, thanks to the control method, it is possible to identify the periods when the users are <<lying>> by crossing the presence/absence data with the instantaneous consumption. indeed, in these periods, the users are present in the dwelling but there is no significant energy consumption.

According to a feature of the invention, the control method integrates a self-learning function according to which the current and past actions are recorded so as to determine scenarios therefrom.

According to another feature of the invention, the control method comprises a step of determining the energy efficiency.

According to a feature of the invention, the step of determining the energy efficiency comprises the following sub-steps:
analyzing the consumption during a phase of the appliance, for example the start-up or the operation or the standby or the turning off,
comparing this analysis with the determination of the use and operation habits of the room or the dwelling, in particular by deducting the share of the consumptions due to the appliances, which allows discerning the number and the power required by these appliances.

The determination of the energy efficiency allows optimizing the turning on of an appliance in anticipation of the habits of the users.

According to a feature of the invention, the control method comprises a step of supervising the energy consumption of the appliance(s) in which the average consumption of these appliances is determined and an over-consumption or an under-consumption is detected from the classification of data.

Thanks to this supervising step, it is possible to detect defects, failures or malfunctions of both appliances with autonomous operation as well as refrigeration, heating appliances and so on.

For example, thanks to the method, it is possible to switch to very advanced energy saving mode (certainty that the door will not open for x hours) an appliance of the room or the dwelling according to the presence/absence of the users and according to the estimated time of the return of said users.

The method according to the invention also allows detecting a technical problem for example, a refrigerator with an open door while the users are absent.

The method according to the invention also allows anticipating the needs, for example an electric water heater which waits for the best time for heating the water, thanks to the information of the return time of the users or the wake-up time.

Furthermore, according to a feature of the invention, the presence/absence information as well as the instantaneous consumption may be used to determine whether the users are lying or not, which allows specifying the use habits of and refining the anticipation of some actions.

According to the invention, the control system allowing the implementation of the control method according to the invention, comprises:
at least one energy consumption sensor configured to sense energy consumption data,
a data analysis unit configured to analyze the data sensed by the at least one sensor,
a control unit of said appliances configured to cooperate with the analysis unit.

According to another feature of the invention, the control system comprises at least one presence/absence sensor.

According to another feature of the invention, the presence/absence sensor may be controlled manually or with automatic detection.

According to another feature of the invention, the control unit monitors by means of outer or inner actuators the consuming appliance(s).

According to another feature of the invention, the control system communicates with the consuming appliance(s) in a wired or a wireless manner, by radio waves,

The invention will be better understood, thanks to the description below, which relates to an embodiment according to the present invention, given by way of non-limiting example and explained below:

A user resides in a dwelling equipped with the control system according to the invention implementing the control method according to the invention.

On Monday, this user leaves his dwelling between 7:50 am and 8:15 am, and this, every Monday. The user signals via a switch or an application or other that he leaves the dwelling,

Thanks to the control method according to the invention it is identified that it is a habit and by using the life habit table created by the past, it may be anticipated that the user will probably return into the dwelling around 6 pm.

The control system will then act as follows, of course it is a non-limiting example of the invention:
managing the heating so that the temperature is comfortable at 6 pm but that the energy consumption is the lowest possible between 8 am and 6 pm, for this, the analysis unit of the control system determines the most energy-saving temperature during the absences and calculates the time of temperature rise in order to ensure that the temperature at 6 pm meet the expectations of the user.
breaking one or more electrical circuit(s), such as a socket circuit on which standby appliances and electrical lighting circuits of the dwelling are connected.

Thus, it is ensured that the dwelling consumes as little energy as possible during absence and that the risk that an appliance or a lighting is always turned on is avoided.

Upon the return of the user around 6 pm, the control system will wait until there is no more significant electrical consumption in the dwelling, which corresponds to the bedtime, in order to gradually reduce the temperature according to an instruction <<night>> for example,

Thus, the control method allows the automatic programming and the adjustment in real time to the needs of the users, without human intervention, only by learning the energy consumptions and by analyzing the consumption signatures of the appliances.

Once each appliance of the dwelling is identified, (step of determining the type of appliance), it is much easier to provide for the consumptions in advance and to apply the most effective scenario.

Furthermore, thanks to the control method and its control system, it is possible to detect at any time a consumption anomaly and to alert the user of the anomaly. For example, in the case of a solar water heater which no longer operates, the control system alerts the user by indicating an over-consumption compared to the habits.

Of course, the invention is not limited to the embodiment described. Modifications remain possible, in particular from the point of view of the constitution of the various elements or by substitution of technical equivalents, without departing from the protection field of the invention.

1-10. (canceled)

11. A method for controlling at least one energy-consuming appliance within a room or a dwelling, implemented by a control system comprising at least one energy consumption sensor configured to measure values representative of energy consumption, called energy consumption data, an analysis unit configured to analyze the measured energy consumption data, a control unit of the at least one appliance configured to cooperate with the analysis unit, the control method comprising at least one step of acquiring energy consumption data measured by the energy consumption sensor and recorded by the analysis unit and a step of determining whether the room or the dwelling is occupied by the analysis unit from the measured, recorded and analyzed energy consumption data,
wherein the control method further comprises:
a) a step of determining the use habits of a user and the operation habits of the room or the dwelling, said step comprising the following sub-steps:
classifying the energy consumption data from the recording and the analysis made previously, the classification being made according to the type of consumption of each energy-consuming appliance of the room or the dwelling: resistive and/or capacitive and/or inductive consumption; and/or according to the average value and/or the frequency and/or the duration and/or the maximum and minimum values of said energy consumption data,
analyzing the occurrence frequency of distinct consumption cycles from the recording of the energy consumption data by the analysis unit and/or the determination of whether the room or the dwelling is occupied for example by a presence sensor,
determining the type of appliance according to the occurrence frequency of the energy consumptions and/or the presence/absence of a user, from the classification of the energy consumption data and the analysis of the occurrence frequency of the energy consumption data forming consumption cycles,
b) a step of controlling the appliance(s) of the room or the dwelling, from the step of determining the use habits of a user and the operation habits of the room or the dwelling.

12. The control method according to claim 11, wherein the step of acquiring the energy consumption data comprises the following sub-steps:
receiving the energy consumption data by the analysis unit,
recording said data in a time table showing the consumption over a determined period.

13. The control method according to claim 11, wherein the step of determining whether the room or the dwelling is occupied comprising the following sub-steps:
acquiring presence/absence data of one or more user(s) in the room or dwelling by means of a presence/absence sensor of the control system,
analyzing the data acquired by the sensor or by the analysis unit of the control system.

14. The control method according to claim 11, wherein at least one first cycle is identified from the records of the consumption data, the first cycle being a cycle called machine cycle, grouping the consumptions performed unrelated to the presence/absence of a user in the room or the dwelling.

15. The control method according to claim 14, wherein at least one second cycle identified from the records of the consumption data, the second cycle being a cycle called user cycle, grouping the consumptions which are related to the presence/absence of one or more user(s).

16. The control method according to claim 15, comprising a step of determining the consumption share of the appliance(s) in a user cycle by comparing the machine cycle(s) with the user cycle(s).

17. The control method according to claim 11, further comprising a step of creating a life habit table, said step comprising the following sub-steps:
creating a data table indicating the standard consumptions of the appliances from the determination of the type of product,
creating a data table indicating the standard consumptions of the dwelling or the room according to the presence/absence of the users.

18. The control method according to claim 11, comprising a step of determining the energy efficiency.

19. The control method according to claim 18, wherein the step of determining the energy efficiency comprises the following sub-steps:
analyzing the consumption during a phase of the appliance,
comparing this analysis with the determination of the use and operation habits of the room or the dwelling which allows discerning the number and the power required by these appliances.

20. The control method according to claim 11, comprising a step of supervising the energy consumption of the appliance(s) in which the average consumption of these appliances is determined and an over-consumption or an under-consumption is detected from the classification of data.
